(19) United States
(12) Patent Application Publication
(10) Pub. No.: US 2006/0102247 A1
(43) Pub. Date: May 18, 2006

(54) Tool holder for supporting a cutting tool

(76) Inventor: Kevin J. Green, Blissfield, MI (US)

Correspondence Address: BURGESS LAW OFFICE, PLLC, P. O. BOX 214320, AUBURN HILLS, MI, 48321-4320, US

(21) Appl. No.: 10/989,789

(22) Filed: Nov. 16, 2004

(51) Int. Cl. A01G 23/06; B27C 1/00; B27G 13/00; B27M 3/00; B27C 5/00

(52) U.S. Cl. 144/24.12; 144/172; 144/176; 144/235

(57) ABSTRACT

The present invention is a tool holder for use in securing a cutting tool or cutting tooth to a cutting wheel of a stump cutting apparatus. The tool holder is typically held to the cutting wheel of the stump cutting apparatus with a threaded fastener. The tool holder includes a bore therein operative to receive the threaded fastener. The bore includes a threaded portion and a non-threaded portion, the non-threaded portion positioned adjacent the inner surface of the tool holder. Whereby, the shank portion of the threaded fastener fits within the non-threaded portion of the tool holder such that the shank portion of the threaded fastener extends across the tool holder/cutting wheel interface.

### 1. FIELD OF THE INVENTION

The present invention relates generally to a stump cutting apparatus and, more specifically, to a tool holder used to attach a cutting tool to a cutting wheel of a stump cutting apparatus.

### 2. BACKGROUND OF THE INVENTION

Various types of stump cutting devices are known in the art. A typical stump cutting apparatus includes a rotatable cutting wheel or drum having a plurality of cutting tools fastened circumferentially about the wheel or drum. Typically, a pair of tool holders or pockets are attached across from each other on opposite sides of the cutting wheel. One of the tool holders having at least one, and preferably a pair of, counterbored apertures that extend through the tool holder. The other tool holder having at least one, and preferably a pair of, threaded apertures that extend through the tool holder.

A fastener, such as a bolt or screw, extends through the counterbored aperture in the tool holder, through an aperture in the cutting wheel, and threadably engages the threaded aperture on the opposite tool holder. Accordingly, when the fastener is tightened, it draws the tool holders together in such a way that they sandwich the cutting wheel between them.

It should be understood that the loads applied to the cutting tooth and corresponding tool holder or mounting block during the cutting operation sometimes cause a crack or fracture in the fastener, usually at the interface between the tool holder and cutting wheel.

Accordingly, there is a need in the art for a tool holder that reduces the likelihood that the fastener used to secure the tool holder to the cutting wheel will fracture at the tool holder/cutting wheel interface. Such a tool holder helps reduce any downtime associated with having to stop the cutting operation and reattach a new tool holder to the cutting wheel.

### SUMMARY OF THE INVENTION

The present invention is a tool holder used to hold in position and support a cutting tool on a cutting wheel of a stump cutting apparatus. The tool holder includes an aperture. The aperture having a threaded portion that receives a threaded portion of a fastener used to secure the tool holder to the cutting wheel of the stump cutting apparatus. The threaded portion of the aperture being spaced from the inner face or mounting surface of the tool holder.

Accordingly, the threaded portion terminates or ends prior to reaching the inner face. Thus, the aperture has a non-threaded portion that extends inward from the inner face or mounting surface of the tool holder. The inner face being the side of the tool holder that is placed next to or adjacent the cutting wheel. In the preferred embodiment, the non-threaded portion of the aperture is configured and sized to receive the shank or non-threaded portion of a threaded fastener.

When the tool holder is attached to the cutting wheel, the threaded portion of the fastener is contained entirely within the tool holder. The fastener is threadably received in the tool holder in such a way that the shank or non-threaded portion of the fastener is positioned and correspondingly extends across the tool holder and cutting wheel interface. This increases the cross-sectional area of the fastener at the tool holder/cutting wheel interface and takes advantage of the increased shear strength of the fastener, since the shear strength of the fastener is greater at the non-threaded portion than at the threaded portion. Accordingly, the fastener may better absorb and withstand the shear loads born by the fastener during operation of the stump cutting apparatus.

### BRIEF DESCRIPTION OF THE DRAWINGS

FIG. 1 is an elevational view of a stump cutting tool assembly illustrating a tool holder used with a stump cutting apparatus, according to the present invention.

FIG. 2 is a perspective view of a stump cutting tool of the present invention shown secured to the cutting wheel of FIG. 1.

FIG. 3 is a partial perspective view of a tool holder, according to the present invention.

FIG. 4 is a cross-sectional view of the cutting tool assembly taken along the lines 4-4 of FIG. 1.

### DETAILED DESCRIPTION OF THE INVENTION

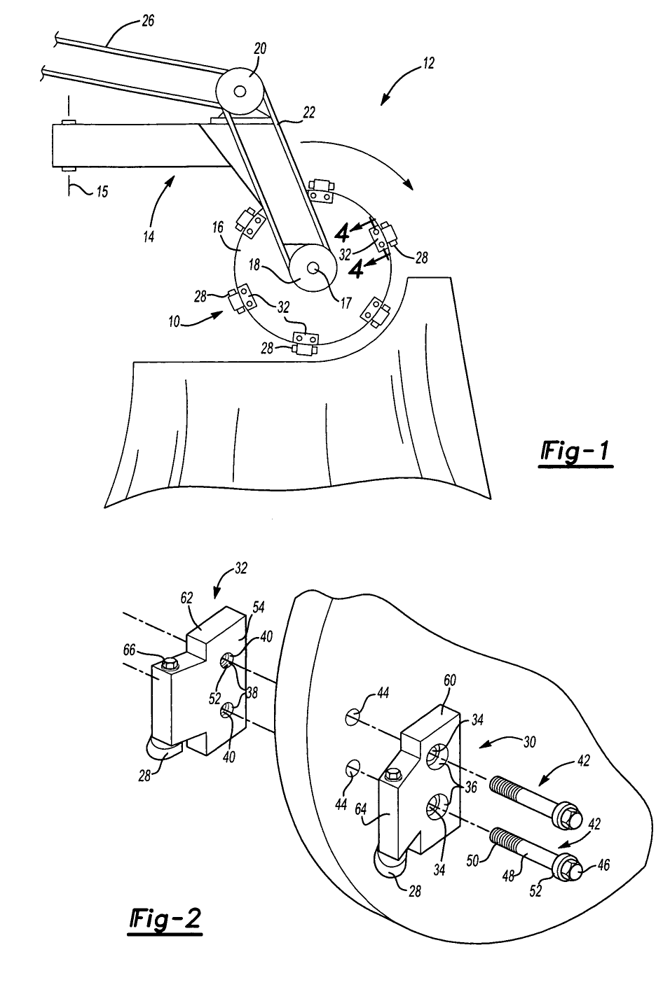

Referring now to FIG. 1, a cutting tool/tool holder assembly 10 is shown secured to a cutting wheel or drum 16 of a stump cutting apparatus, seen generally at 12. The cutting tool/tool holder assembly 10 includes a tool holder 32 and a cutting tool 28 secured thereto. The stump cutting apparatus 12 includes a wheel frame 14 pivotally supported for pivotal movement about an axis 15 to a remaining portion (not shown) of the stump cutting apparatus 12.

The cutting wheel or drum 16 is rotatably mounted at the other end of the wheel frame 14 for rotational movement about an axis 17. The stump cutting apparatus 12 also includes a first pulley 18 attached to the cutting wheel or drum 16 and a second pulley 20 attached to the wheel frame 14. A belt 22 interconnects the first pulley 18 and the second pulley 20. A third pulley (not shown) connects to the second pulley 20 and a second belt 26 connects the third pulley (not shown) with a rotational source such as a motor (not shown). The rotational source rotatably moves the second belt 26 to rotate the third pulley (not shown), which in turn rotates the second pulley 20. Rotation of the second pulley 20 causes the first belt 22 to move; in turn rotating the first pulley 18 and, correspondingly, the cutting wheel or drum 16. It should be understood that a stump cutting apparatus 12 of this type is conventional and known in the art.

FIGS. 2-4 show the cutting tool/tool holder 10 assembly including a tool holder 32 according to the present invention used to secure a cutting tool 28 to the cutting wheel 16 of the stump cutting apparatus 12. The tool holder 32 may also be referred to as a pocket or mounting block. As is known, tool holders, pockets or mounting blocks as they are often referred to, are used to secure a cutting tool 28 to the cutting wheel 16 of a stump cutting apparatus 12.

Typically, a plurality of cutting tool/tool holder assemblies 10 are secured or mounted to the cutting wheel 16. In accordance with the disclosed embodiment, the cutting tool/tool holder assembly 10 typically includes first and second tool holders 30, 32, that are secured in pairs to opposite sides of the cutting wheel 16. The first tool holder 30 includes a bore or aperture 34 having an adjacent countersunk portion 36. As shown in FIG. 2, each of the first and second tool holders 30, 32 includes a body portion 60, 62 and a tool portion 64, 66. Each body portion 60, 62 is secured to the cutting wheel 16, while each tool portion 64, 66 is used to support the cutting tool 28.

It should be understood that the present invention is also suitable for use with tool holders or mounting blocks of the type used to sandwich or clamp the shank of a cutting bit between the tool holder and cutting wheel. The invention is also suitable for use with one piece cutting tools which are normally secured as a single or unitary piece to the cutting wheel. It is apparent that the present invention is used to secure the tool holder to a cutting wheel irrespective of the style, design or type of cutting tooth or bit that is used, attached or held in place by the various types of tool holders, mounting blocks or pockets.

FIG. 2 shows the tool holder 32 in greater detail, according to the present invention. The second tool holder 32 having an inner face or mounting surface 54 and an outer face 58. It should be understood that the inner face or mounting surface 54 of the tool holder 32 is the side of the tool holder 32 that contacts the cutting wheel 16 when the tool holder 32 is secured to the cutting wheel 16. The second tool holder 32 includes a bore or aperture 38. The bore or aperture 38 includes a plurality of threads 40 spaced from the inner face or mounting surface 54 of the tool holder 32.

While the preferred embodiment illustrates that the second tool holder 32 has a bore or aperture 38, it is within the scope of the invention for the bore or aperture 38 to be a blind bore or socket that does not extend through the second tool holder 32 from the inner face or mounting surface 54 to the outer face 58 thereof.

Fasteners 42 are used to secure the respective tool holders 30, 32 to the cutting wheel 16. The fasteners 42 extend through the bore 34 of the first tool holder 30, through an aperture or bore 44 in the cutting wheel 16, and threadably engage at least a portion of the plurality of threads 40 located in the second tool holder 32, which is normally positioned opposite the first tool holder 30. Accordingly, tightening the fastener 42 draws the respective first and second tool holders 30, 32 together, whereby they sandwich the cutting wheel 16 between them and are thus secured to the cutting wheel 16. Although only two fasteners 42 are shown to secure the first and second tool holders 30, 32 to the cutting wheel 16, additional fasteners may also be used.

The fasteners 42 typically include a head portion 46, a shank portion 48 and a plurality of threads 50 located on the shank portion 48. The head portion 46 is shown in the present embodiment having a hexagonal shape over which a driving tool, such as a socket (not shown), is placed and used to rotate and correspondingly tighten the fasteners 42. The fasteners 42 are tightened until the underside or shoulder surface 52 engages the countersunk portion 36 located on the first tool holder 30. Whereby the fastener 42, being threadably engaged with the second tool holder 32, draws the respective tool holders 30, 32 together to sandwich the cutting wheel 16 between them.

While shown in the present embodiment as having a hexagonal shaped head 46, this is for illustration purposes only. The fastener 42 may utilize other types of driving systems such as socket head screws, torx, square or other configurations, all of which are capable of rotating the fastener 42 and still remain within the scope of the invention.

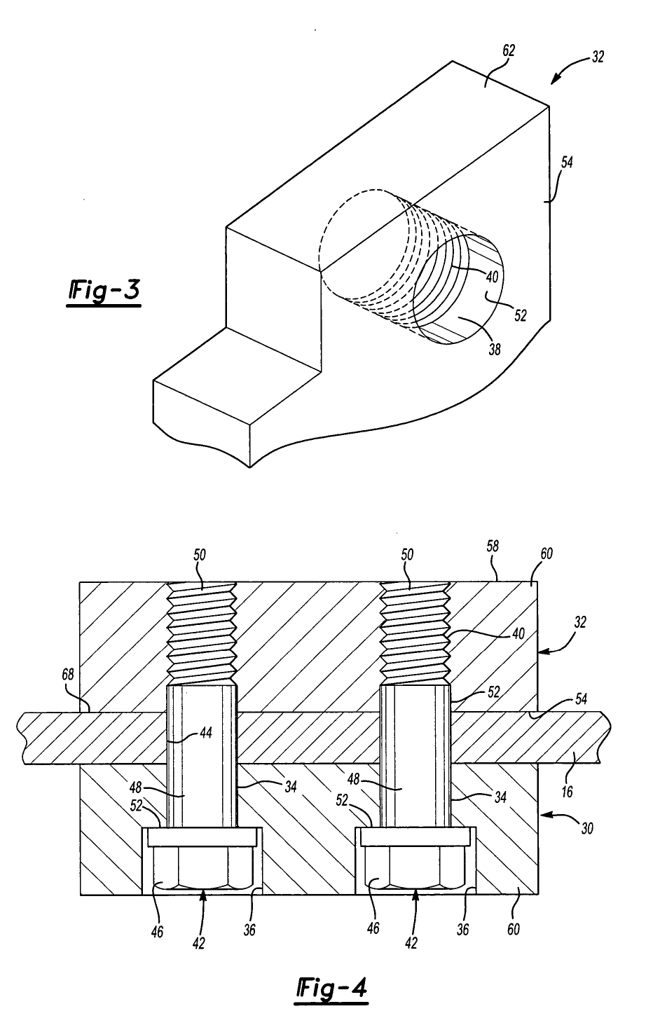

As shown in FIGS. 3-4, the plurality of threads 40 located in the bore or aperture 38 on the second tool holder 32 do not extend all the way to the inner face or mounting surface 54 of the tool holder 32. Thus, the threaded portion or plurality of threads 40 located in the bore or aperture 38 terminates prior to reaching the inner face or mounting surface 54 of the tool holder 32. Accordingly, the bore or aperture 38 includes a non-threaded portion 52 that extends inwardly from the inner face or mounting surface 54 towards the plurality of threads or threaded portion 40 of the tool holder 32.

As indicated, one side of the non-threaded portion 52 of the bore or aperture 38 is adjacent to the inner face or mounting surface 54 of the tool holder 32. In addition, the non-threaded portion 52 typically has a diameter similar in size to that of the bore 34 in the first tool holder 30, and complementary to the outer diameter of the shank portion 48 of the fastener 42 wherein the shank portion 48 extends into the second tool holder 32 (See FIG. 4).

Configuring the tool holder 32 in this manner enables the fastener 42 to extend into the second tool holder 32 in a manner wherein the shank portion 48 of the fastener 42 extends past the interface 68 between the second tool holder 32 and the cutting wheel 16. Extending the shank portion 48 into the second tool holder 32 in this manner provides for increased shear resistance of the fastener 42 at the second tool holder 32 and cutting wheel 16 interface 68. The increased shear resistance at the second tool holder 32 and cutting wheel 16 interface 68 results from an increase or uniform cross-section of the fastener 42 at the interface 68. As opposed to placing the threaded portion 50 of the fastener 42 at, or in close proximity to, the interface 68 whereby the threaded portion 50 forms a weak point at which the fastener 42 typically tends to crack or break.

Accordingly, the present invention provides a tool holder 32 having a bore or aperture 38 having a threaded portion 40 and a non-threaded portion 52. In this way, the shank portion 48 of the fastenerr 42 extends into the non-threaded portion 52 of the bore or aperture 38 and provides greater support and resistance to shear loads and possible fastener failure at the interface 68 between the tool holder 32 and cutting wheel 16. It should be understood that the depth of or distance that the non-threaded portion 52 of the bore or aperture 38 extending inward from the inner face or mounting surface 54 of the tool holder 32, is variable depending upon the size, diameter and type of fastener 42 used, along with the loads occurring during the cutting operation.

By way of example only, in the present invention, the non-threaded portion 52 of the tool holder 32 extends inward a distance roughly the same as the thickness of the outer diameter of the non-threaded or shank portion 48 of the fastener 42 to take the greatest advantage of the shear strength of the fastener 42. In some instances, depending upon the width of the tool holder 32, the amount or length of the non-threaded portion 52 of the tool holder 32 may be greater or less than the thickness of the outer diameter of the non-threaded or shank portion 48 of the fastener 42. The amount or length thereof further depending on the amount or number of threads necessary to properly secure the tool holders 30, 32 to the cutting wheel 16.

It will thus be seen that the objects of the invention have been fully and effectively accomplished. It will be realized, however, that the foregoing specific embodiments have been shown and described for the purposes of illustrating the functional and structural principles of the invention and is subject to change without departure from such principles. Therefore, this invention includes all modifications encompassed within the scope of the following claims.

What is claimed is:

1. A tool holder for supporting a cutting tool on a cutting wheel of a stump cutting apparatus comprising:
a body, said body having an inner face and an outer face, said body including an aperture extending into said body from said inner face toward said outer face; and
a plurality of threads located in a portion of said aperture, said plurality of threads terminating prior to reaching said inner face.

2. A tool holder for supporting a cutting tool on a cutting wheel as set forth in claim 1 wherein said aperture extends between said inner face of said body and said outer face of said body, said plurality of threads forming a threaded portion of said aperture, said aperture further having a non-threaded portion, said non-threaded portion positioned nearer to said inner face of said body then said threaded portion.

3. A tool holder for supporting a cutting tool on a cutting wheel as set forth in claim 2 wherein said non-threaded portion extends from said inner face of said body toward said outer face.

4. A tool holder for supporting a cutting tool on a cutting wheel as set forth in claim 3 wherein said threaded portion is positioned adjacent said non-threaded portion.

5. A tool holder for supporting a cutting tool on a cutting wheel as set forth in claim 3 wherein said non-threaded portion extends inward into said body from said inner face of said body a distance that is at least five percent of the total width of said body of said tool holder from said inner face to said outer face.

6. A tool holder for supporting a cutting tool on a cutting wheel as set forth in claim 3 wherein said non-threaded portion extends inward into said body from said inner face of said body a distance that is at least twenty-five percent of the total distance of said tool holder from said inner face to said outer face.

7. A tool holder for supporting a cutting tool on a cutting wheel as set forth in claim 3 wherein said non-threaded portion extends from said inner face of said body a distance approximately that of the diameter of the shank portion of the fastener.

8. A tool holder for supporting a cutting tool on a cutting wheel of a stump cutting apparatus comprising:
a body, said body having an inner face and an outer face;
said body further having a bore; and
a plurality of threads located in said bore, said plurality of threads forming a threaded portion of said bore, said threaded portion extending for a distance covering at least a part of the width of said tool holder between said inner face and said outer face, said bore further including a non-threaded portion extending from said inner face toward said threaded portion, said non-threaded portion having a diameter of a size suitable to receive a shank of a fastener used to secure the tool holder to the cutting wheel.

9. A tool holder for supporting a cutting tool on a cutting wheel of a stump cutting apparatus as set forth in claim 8 wherein said non-threaded portion extends inwardly from said inner face a distance approximately that of the diameter of the shank of the fastener.

10. A tool holder for supporting a cutting tool on a cutting wheel of a stump cutting apparatus as set forth in claim 8 wherein the diameter of said threaded portion is less than the diameter of the non-threaded portion.

11. A tool holder for supporting a cutting tool on a cutting wheel of a stump cutting apparatus as set forth in claim 8 wherein said bore extends between said inner face and said outer face.

12. A tool holder for supporting a cutting tool on a cutting wheel of a stump cutting apparatus as set forth in claim 11 wherein said non-threaded portion extends inward from said inner face of said body a distance approximately that of the diameter of the shank portion of the fastener.

13. A tool holder for supporting a cutting tool on a cutting wheel of a stump cutting apparatus as set forth in claim 11 wherein said threaded portion is positioned adjacent said non-threaded portion and extends from said non-threaded portion to said outer face of said body.

14. A tool holder for supporting a cutting tool on a cutting wheel of a stump cutting apparatus as set forth in claim 8 wherein said bore extends substantially perpendicular to said inner face.

15. A cutting tool assembly for use with a stump cutting apparatus, the cutting tool assembly secured to a cutting wheel of the stump cutting apparatus with a threaded fastener having a shank portion and a threaded portion comprising:
a first tool holder having at least one bore extending between an inner face and an outer face, said bore having a diameter suitable to receive the shank portion of the fastener; and
a second tool holder, said second tool holder having at least one bore contained therein, said bore extending between an inner face and an outer face of said second tool holder, said bore including a threaded portion and a non-threaded portion, said non-threaded portion of said bore located adjacent the inner face of said second tool holder.

16. A cutting tool assembly for use with a stump cutting apparatus as set forth in claim 15 wherein said first tool holder includes a counterbore formed in the outer face of said first tool holder, said counterbore being generally circular and having a diameter greater then said diameter of said bore extending between said outer face and said inner face, said counterbore sized to receive a head portion of the threaded fastener wherein said head portion is disposed below said outer face of said first tool holder when said first tool holder is secured to the cutting wheel.

17. A cutting tool assembly for use with a stump cutting apparatus as set forth in claim 15 wherein said non-threaded portion extends inwardly from said inner face of said second tool holder towards said outer face a distance approximately that of the diameter of the shank of the fastener.

18. A cutting tool assembly for use with a stump cutting apparatus as set forth in claim 15 wherein said threaded portion extends from said non-threaded portion to said outer face of said second tool holder.

19. A cutting tool assembly for use with a stump cutting apparatus as set forth in claim 15 wherein a diameter of said threaded portion is less than the diameter of said non-threaded portion.

20. A cutting tool assembly for use with a stump cutting apparatus as set forth in claim 15 including said non-threaded portion extending inwardly from said inner face of said second tool holder;
said threaded portion extending from said non-threaded portion to said outer face of said second tool holder; and
said bore extending substantially perpendicular to said inner face of said second tool holder.
